(19) United States
(12) Patent Application Publication
(10) Pub. No.: US 2026/0301702 A1
(43) Pub. Date: Oct. 1, 2026

(54) DISPLAY DEVICE

(71) Applicant: Sharp Kabushiki Kaisha, Sakai City (JP)

(72) Inventors: Shunsuke NOICHI, Sakai City (JP); Noriyuki TANAKA, Sakai City (JP)

(21) Appl. No.: 19/576,343

(22) Filed: Mar. 24, 2026

(30) Foreign Application Priority Data
Mar. 27, 2025 (JP) 2025-054129

(51) Int. Cl. G09G 3/34; G09G 3/36

(52) U.S. Cl. CPC G09G 3/3426; G09G 3/3607; G09G 2320/0626; G09G 2320/068; G09G 2320/0686; G09G 2358/00

(57) ABSTRACT

A display device capable of presenting a first image to a first user positioned at a first location in front of a display surface and also of presenting a second image to a second user positioned at a second location other than the first location, the display device including a backlight divided into a plurality of two-dimensional areas, wherein the backlight includes a light source in each of the plurality of two-dimensional areas, the light sources are independently controllable in each of the plurality of two-dimensional areas of the backlight, and a control unit of the display device specifies a luminance for each of the plurality of two-dimensional areas of the backlight by controlling the light sources in the backlight in accordance with a display mode of the first image and the second image.

### CROSS-REFERENCE TO RELATED APPLICATIONS

This application claims the benefit of priority to Japanese Patent Application Number 2025-054129 filed on Mar. 27, 2025. The entire contents of the above-identified application are hereby incorporated by reference.

### FIELD OF THE DISCLOSURE

The present disclosure, in an aspect thereof, relates to display devices.

### BACKGROUND OF THE DISCLOSURE

A display device that can present a plurality of individual images on a single display surface in accordance with the viewing direction of the user (viewer) is called a multi-view display device.

WO-A-2006/109498 discloses an exemplary structure of such a multi-view display device.

### SUMMARY

### Problems to be Solved by the Invention

It is an object of one aspect of the present disclosure to improve the display quality of a multi-view display device over known devices.

### Solution to the Problems

The present disclosure, in one aspect thereof, is directed to a display device capable of presenting a first image to a first user positioned at a first location in front of a display surface and also of presenting a second image to a second user positioned at a second location other than the first location, the display device including: a display panel including a first display pixel group that contributes to formation of the first image on the display surface and a second display pixel group that contributes to formation of the second image on the display surface; a backlight configured to discharge illumination light toward the first display pixel group and the second display pixel group; a barrier configured to prevent part of first light produced by wavelength-converting the illumination light with the first display pixel group and part of second light produced by wavelength-converting the illumination light with the second display pixel group from traveling toward the display surface; and a control unit configured to control the display panel and the backlight, wherein the backlight is divided into a plurality of two-dimensional areas, the backlight includes a light source in each of the plurality of two-dimensional areas, the light sources are independently controllable in each of the plurality of two-dimensional areas of the backlight, and the control unit specifies a luminance for each of the plurality of two-dimensional areas of the backlight by controlling the light sources in the backlight in accordance with a display mode of the first image and the second image.

### Advantageous Effects of the Invention

The present disclosure, in an aspect thereof, can improve the display quality of a multi-view display device over known devices.

### BRIEF DESCRIPTION OF DRAWINGS

FIG. 1 is a block diagram of an exemplary structure of a display device in accordance with Reference Embodiment.

FIG. 2 schematically shows a dual view display in accordance with Reference Embodiment.

FIG. 3 is a diagram illustrating an operation example of a dual view display in accordance with Reference Embodiment.

FIG. 4 is a block diagram of an exemplary structure of a display device in accordance with Embodiment 1.

FIG. 5 schematically shows an image display in dual view mode in accordance with Embodiment 1.

FIG. 6 is a schematic diagram illustrating an operation example of an LD-type BL.

FIG. 7 shows an example of a plurality of two-dimensional areas of a BL in a display device in accordance with Embodiment 1.

FIG. 8 shows an example of a first image, a second image, and a BL luminance distribution in dual view mode in accordance with Embodiment 1.

FIG. 9 schematically shows an image display in public mode in accordance with Embodiment 1.

FIG. 10 shows an example of a first image and a second image, both as a common image, and a BL luminance distribution in public mode in accordance with Embodiment 1.

FIG. 11 schematically shows an image display in privacy mode in accordance with Embodiment 1.

FIG. 12 shows an example of a first image, a second image as a black display image, and a BL luminance distribution in privacy mode in accordance with Embodiment 1.

### DESCRIPTION OF EMBODIMENTS

### Reference Embodiment

A display device 1 as Reference Embodiment is described prior to the description of a display device 1P in accordance with Embodiment 1. For convenience of description, components (structural elements) that have the same function as components described in Reference Embodiment will be denoted by the same reference numerals throughout the subsequent embodiments, and description thereof is not repeated. In addition, for the sake of simplicity, description of the same matters as in publicly known technology is also omitted where appropriate. The components and numerical values described in the present specification are all merely illustrative as long as the description is reasonably consistent in content. Therefore, for example, the positional and connection relationships of the components are not limited to the examples shown in the drawings as long as the description is reasonably consistent in content.

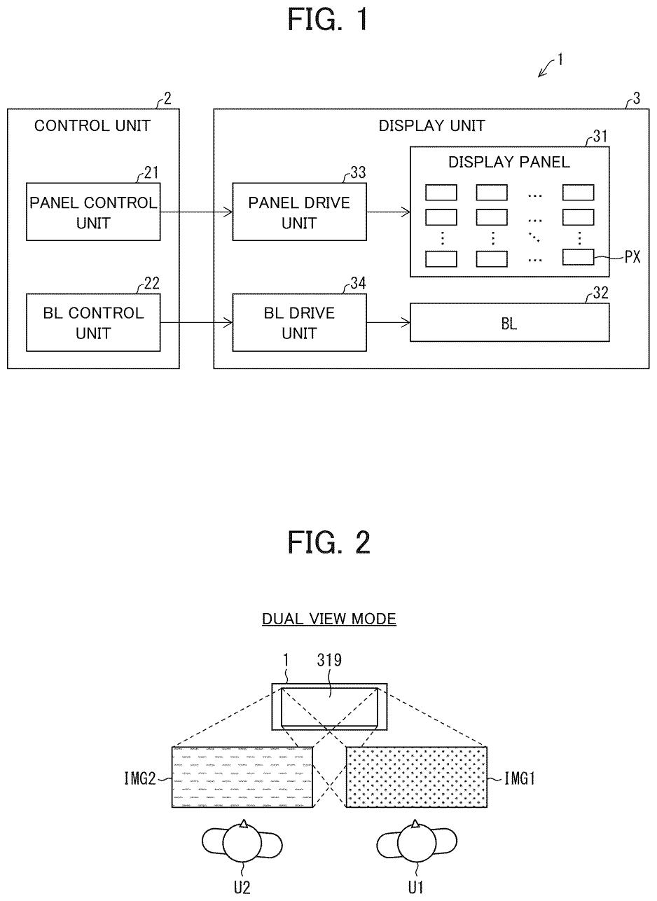

FIG. 1 is a block diagram of an exemplary structure of the display device 1. The display device 1 includes a control unit 2 and a display unit 3. The display device 1 may be either a mobile information terminal or a desktop display device. A “backlight” is abbreviated to “BL” in the present specification. The display device 1 is typically a liquid crystal display device.

The control unit 2 collectively controls the components of the display device 1. The control unit 2 in accordance with Reference Embodiment functions as a display control device for controlling displays produced on the display unit 3. The control unit 2 includes a panel control unit 21 and a BL control unit 22. Therefore, the control unit 2 controls a display panel 31 and a BL 32 both of which will be described later in detail.

The panel control unit 21 generates liquid crystal data that corresponds to an input image. The liquid crystal data is a set of data that represents the spatial distribution of the liquid crystal transmittance (optical transmittance of the liquid crystal) in the display panel 31. The panel control unit 21 feeds the generated liquid crystal data to a panel drive unit 33 described later in detail.

The BL control unit 22 generates BL data that corresponds to the input image. The BL data is a set of data that represents the spatial distribution of luminance in the BL 32. The BL control unit 22 feeds the generated BL data to a BL drive unit 34 described later in detail.

The display unit 3 displays an input image as instructed by the control unit 2. The display unit 3 is typically a liquid crystal display device. In the example in FIG. 1, the display unit 3 includes the display panel 31, the BL 32, the panel drive unit 33, and the BL drive unit 34.

The display panel 31 has a display area in which a plurality of display pixels PX are arranged in a pattern. The display panel 31 is typically a liquid crystal display panel. The display panel 31 displays a prescribed image as instructed by the control unit 2.

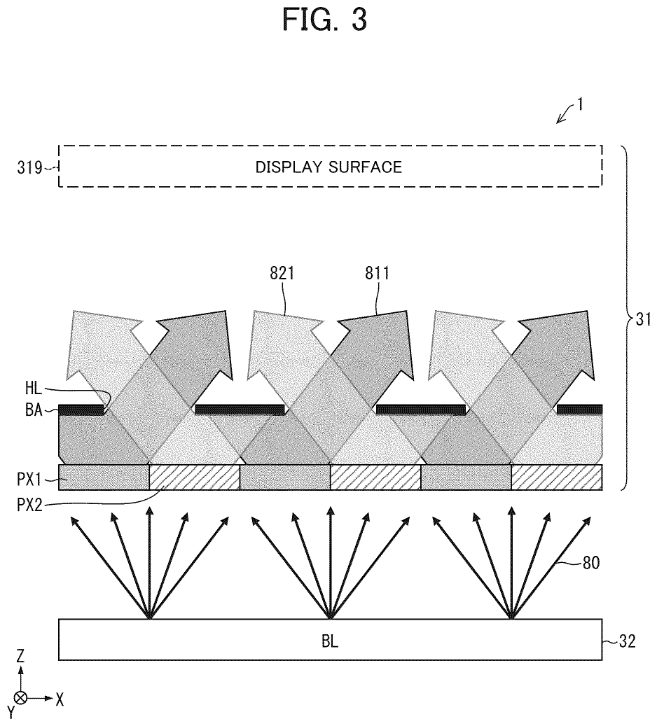

For convenience of description, the present specification uses an XYZ Cartesian coordinate system shown in, for example, FIG. 3 detailed later. The X-direction and the Y-direction correspond respectively to the column direction and the row direction of the display panel 31. As can be understood from FIG. 3, the Z-direction is the normal to a display surface 319 of the display panel 31. The present specification assumes that the user of the display device 1 is positioned on the positive Z-direction side. For this reason, the positive Z-direction side may be referred to as the viewer side. Meanwhile, the negative Z-direction side may be referred to as the substrate side. The Z-direction in the present specification is also the thickness direction of the display device 1.

As can be understood from the foregoing description, the XY-plane in the present specification is a plane parallel to the display surface 319 of the display panel 31. Referring to FIG. 1, the display panel 31 includes the plurality of display pixels PX arranged regularly in both the X-direction and the Y-direction.

The BL 32 includes a light source (not shown in the drawings for Reference Embodiment). The light source may be any type of light-emitting element. The BL 32 needs only to include at least one light source. The spatial distribution of luminance in the BL 32 can be controlled by controlling the emission of light by the light-emitting element. The BL 32 discharges illumination light toward the display unit 3.

The present specification discusses an example where the BL 32 includes a white LED (light-emitting diode) as the light source. Therefore, the present specification discusses an example where the illumination light is white light. In Reference Embodiment, all the light sources in the BL 32 are uniformly controlled. In other words, the BL 32 in accordance with Reference Embodiment is a non-LD (local dimming) type of BL.

The panel drive unit 33 drives the display panel 31 in accordance with the liquid crystal data acquired from the panel control unit 21. Specifically, the panel drive unit 33 changes the optical transmittance at each location in the display panel 31 in accordance with this liquid crystal data.

The BL drive unit 34 drives the BL 32 in accordance with the BL data acquired from the BL control unit 22. Specifically, the BL drive unit 34 controls the light-emission state of the BL 32 in accordance with this BL data. More specifically, the BL drive unit 34 controls the light-emission luminance of the light source in the BL 32 in accordance with this BL data.

As described so far, the control unit 2 displays an input image on the display panel 31 by (i) driving the display panel 31 through the panel drive unit 33 and also (ii) driving the BL 32 through the BL drive unit 34.

The display device 1 in accordance with Reference Embodiment is a multi-view liquid crystal display device. For clarity of description, Reference Embodiment discusses an example where the display device 1 is a dual-view liquid crystal display device. Therefore, the display device 1 is configured to be capable of presenting two images (performing a dual view display) in accordance with the viewing direction of the user.

The present specification will refer to one of the two images in the dual view display as a first image and refer to the other image as a second image. The display device 1 in accordance with Reference Embodiment is an example of a publicly known dual-view liquid crystal display device. Reference Embodiment discusses an example where the second image differs from the first image. It should be understood however that as will be discussed as an example in Embodiment 1 which will be described later in detail, the second image in accordance with an aspect of the present disclosure may be the same image (common image) as the first image.

FIG. 2 schematically shows a dual view display by the display device 1. FIG. 2 shows, as an example, two users as viewers of the image displayed by the display device 1. The present specification will refer to one of the two users as a first user U1 and refer to the other user as a second user U2.

Referring to FIG. 2, the display device 1 (specifically, the display panel 31) has the display surface 319. The present specification assumes that the first user U1 is positioned at a first location with respect to the display surface 319 and that the second user U2 is positioned at a second location with respect to the display surface 319. In the present specification, the second location differs from the first location. In the example in FIG. 2, a first image IMG1 is an image presented to the first user U1. Meanwhile, a second image IMG2 is an image presented to the second user U2.

FIG. 2 discusses an example where the display device 1 is operating in dual view mode. In dual view mode, the display device 1 (i) presents the first image IMG1 to the first user U1 and also (ii) presents the second image IMG2, which differs from the first image IMG1, to the second user U2.

The present specification will refer to an image in which all the gray levels are equal to a minimum gray level (that is, equal to gray level 0) as a black display image. Meanwhile, the present specification will refer to an image that is not a black display image as a non-black display image. In the example described in Reference Embodiment, both the first image IMG1 and the second image IMG2 are a non-black display image.

The example in FIG. 2 shows an example where both the first location and the second location are on a lateral side of the display surface 319. As an example, the first location may be on either one of the left side of the display surface 319 and the right side of the display surface 319. In such a case, the second location may be on the other one of the left side of the display surface 319 and the right side of the display surface 319.

In the example in FIG. 2, the first user U1 is toward the right side of the plane of paper with respect to the display surface 319. Meanwhile, the second user U2 is toward the left side of the plane of paper with respect to the display surface 319. Therefore, FIG. 2 represents an example where the second location is opposite the first location. As described here, the second location may be a location on a lateral side of the display surface 319 and may be a location on a lateral side that is opposite the first location.

### Dual View Example in Reference Embodiment

FIG. 3 is a diagram illustrating an operation example of a dual view display by the display device 1. Specifically, FIG. 3 is a diagram illustrating various light involved in a dual view display. A description is given first of an example of a dual-view structure of the display device 1 (hardware configuration for a dual view display device) with reference to FIG. 3.

Referring to FIG. 3, the display panel 31 is positioned on the viewer side when compared to the BL 32. Reference Embodiment discusses an example where the display panel 31 is an RGB (red, green, and blue) liquid crystal display panel. In the example of Reference Embodiment, each display pixel PX includes one red sub-display-pixel, one green sub-display-pixel, and one blue sub-display-pixel.

In the example in FIG. 3, the BL 32 discharges illumination light 80 as white light toward the display pixels PX (specifically, a first display pixel group PX1 and a second display pixel group PX2 both of which will be described later in detail). The illumination light 80 emitted by the light sources in the BL 32 in accordance with Reference Embodiment has a luminance that is uniform regardless of the location of each light source. In the example in FIG. 3, the illumination light 80 is assumed to have no particular directionality.

In the example in accordance with Reference Embodiment, the red sub-display-pixel includes a red color filter, the green sub-display-pixel includes a green color filter, and the blue sub-display-pixel includes a blue color filter. Therefore, of the white light discharged from the BL 32, the white light incident to the red sub-display-pixel is converted to red light. Of the white light discharged from the BL 32, the white light incident to the green sub-display-pixel is converted to green light. Of the white light discharged from the BL 32, the white light incident to the blue sub-display-pixel is converted to blue light. In the display panel 31, the red light, the green light, and the blue light that exit the display pixels PX and travel to the viewer side form an image (specifically, an RGB image) on the display surface 319.

As described above, the display device 1 is a dual-view liquid crystal display device. Therefore, the display panel 31 in the example in FIG. 3 includes the first display pixel group PX1 and the second display pixel group PX2. The first display pixel group PX1 is a group of those display pixels PX that contribute to the display of the first image. Meanwhile, the second display pixel group PX2 is a group of those display pixels PX that contribute to the display of the second image.

The first display pixel group PX1 in the example in FIG. 3 is a group of those display pixels PX that reside in an odd-numbered column. Therefore, for example, those display pixels PX that reside in the first column belong to the first display pixel group PX1. In addition, those display pixels PX that reside in the third column also belong to the first display pixel group PX1. Meanwhile, the second display pixel group PX2 in the example in FIG. 3 is a group of those display pixels PX that reside in an even-numbered column. Therefore, for example, those display pixels PX that reside in the second column belong to the second display pixel group PX2. In addition, those display pixels PX that reside in the fourth column also belong to the second display pixel group PX2.

As described so far, in the display panel 31, the first display pixel group PX1 and the second display pixel group PX2 are alternately arranged in the X-direction. As described here, for example, the first display pixel group PX1 and the second display pixel group PX2 can alternately appear when one observes the display panel 31 along a direction from the first location toward the second location (e.g., along the X-direction).

As shown in FIG. 3, the display panel 31 further includes a barrier BA. The barrier BA needs only to contain any light-absorbing material. The barrier BA may be referred to as the parallax barrier. The barrier BA may alternatively be referred to as the light-blocking section. In the example in FIG. 3, the barrier BA covers parts of the first display pixel group PX1 and also covers parts of the second display pixel group PX2 when the barrier BA is viewed from the display surface 319. In other words, the barrier BA is positioned on the viewer side when compared to the first display pixel group PX1 and the second display pixel group PX2.

In the present specification, the light produced by wavelength-converting (e.g., color-converting) the illumination light 80 discharged from the BL 32 with the first display pixel group PX1 will be referred to as first light. Meanwhile, the light produced by wavelength-converting the illumination light 80 discharged from the BL 32 with the second display pixel group PX2 will be referred to as second light. The barrier BA prevents part of the first light from traveling toward the display surface 319 and also prevents part of the second light from traveling toward the display surface 319.

A description is given next of various light involved in the dual view provided by the display device 1. As described above, the BL drive unit 34 drives the BL 32 as instructed by the BL control unit 22. Therefore, as shown in FIG. 3, the illumination light 80 is discharged from the BL 32 toward the first display pixel group PX1 and the second display pixel group PX2.

Simultaneously, the panel drive unit 33 drives the display panel 31 as instructed by the panel control unit 21. Specifically, the panel drive unit 33 drives both the first display pixel group PX1 and the second display pixel group PX2 as instructed by the panel control unit 21. As described here, the panel control unit 21 drives both the first display pixel group PX1 and the second display pixel group PX2 through the panel drive unit 33 so as to cause the display panel 31 to display the first image IMG1 and the second image IMG2.

As shown in FIG. 3, the barrier BA has openings HL through which the above-described part of the first light and the above-described part of the second light pass. The openings HL in the example in FIG. 3 are positioned so as to partially expose each of the first display pixel group PX1 and the second display pixel group PX2 when viewed from the display surface 319.

Therefore, the first light, which has such a directionality to travel toward the first location, partially passes through the openings HL and travels toward the display surface 319. Light 811 in FIG. 3 is an example of the first light, which has such a directionality to travel toward the first location, passing through the openings HL and traveling toward the display surface 319. Since the light 811 has a directionality to travel toward the first location, the light 811 contributes to the formation of the first image IMG1 on the display surface 319.

Meanwhile, the second light, which has such a directionality to travel toward the second location, partially passes through the openings HL and travels toward the display surface 319. Light 821 in FIG. 3 is an example of the second light, which has such a directionality to travel toward the second location, passing through the openings HL and traveling toward the display surface 319. Since the light 821 has a directionality to travel toward the second location, the light 821 contributes to the formation of the second image IMG2 on the display surface 319.

### Embodiment 1

The inventors for the present application have created the novel display device 1P in accordance with Embodiment 1, which differs from known display devices. As described later in detail, the display device 1P differs from the display device 1 in accordance with Reference Embodiment and is an LD-type multi-view display device. The display device 1P allows for improvement of the display quality of a multi-view display device over known device. Specifically, the display device 1P allows for improvement of the display quality of an LD-type multi-view display device over known devices.

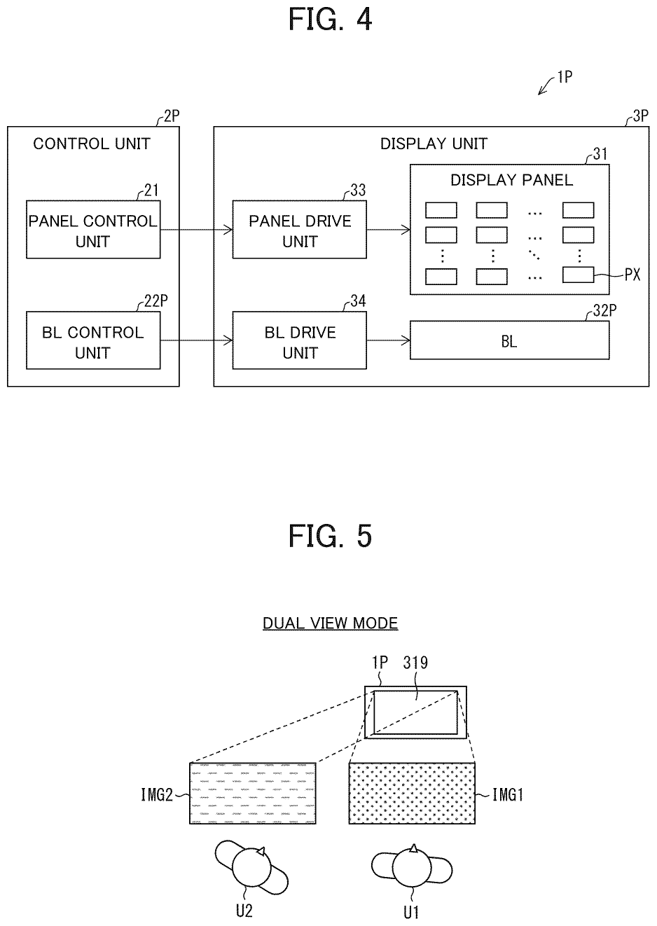

FIG. 4 is a block diagram of an exemplary structure of the display device 1P. FIG. 4 is a drawing corresponding to above-described FIG. 1. The display device 1P includes a control unit 2P and a display unit 3P. The control unit 2P includes a BL control unit 22P in place of the BL control unit 22.

The display unit 3P includes a BL 32P in place of the BL 32. The BL 32P in accordance with Embodiment 1 differs from the BL 32 in accordance with Reference Embodiment and is an LD-type BL. Therefore, the display device 1P is an example of an LD-type multi-view display device.

As will be described later in detail, the display device 1P drives the BL 32P in accordance with the display mode of the display device 1P (more specifically, the display mode of the first image IMG1 and the second image IMG2). Embodiment 1 discusses an example where this display mode includes public mode and privacy mode both of which will be described later in detail, as well as includes dual view mode described in Reference Embodiment.

The display device 1P may switch between different display modes under any preset conditions. As an example, the control unit 2P may switch the display mode of the display device 1P in accordance with the preset conditions. Therefore, the control unit 2P may select a prescribed display mode from three modes, that is, dual view mode, public mode, and privacy mode, in accordance with the conditions.

FIG. 5 schematically shows an image display in dual view mode by the display device 1P. Embodiment 1, similarly to the example in FIG. 2 of Reference Embodiment, discusses an example where the display device 1P, operating in dual view mode, (i) presents the first image IMG1, which is a non-black display image, to the first user U1 positioned at the first location and also (ii) presents the second image IMG2, which is a different non-black display image from the first image IMG1, to the second user positioned at the second location.

It should be understood however that unlike the example in FIG. 2, the first user U1 is positioned in front of the display surface 319 in the example in FIG. 5. Therefore, the first location in the example in FIG. 5 is a location in front of the display surface 319. For this reason, the first image IMG1 in the example in FIG. 5 may be referred to as the front image.

In the example in FIG. 5, the second user U2 is positioned on a lateral side of the display surface 319. In other words, the second location in the example in FIG. 5 is on a lateral side of the display surface 319. For this reason, the second image IMG2 in the example in FIG. 5 may be referred to as the lateral-side image. FIG. 5 represents an example where the second location is toward the left side of the plane of paper with respect to the display surface 319. It should be understood however that unlike the example in FIG. 5, the second location may be toward the right side of the plane of paper with respect to the display surface 319.

As an example, the display device 1P may be provided in an automobile. In other words, the display device 1P may be an onboard display device. In such a case, for example, the first user U1 is a person sitting in a passenger seat in the automobile (non-driver), and the second user U2 is a person sitting in the driver's seat in the automobile (driver).

In such a case, the first image IMG1 in dual view mode is, for example, a content image that is not related to the driving of the automobile (e.g., an entertainment content image). Meanwhile, the second image IMG2 in dual view mode is, for example, a content image that is related to the driving of the automobile (an information image presented by the software included in a car navigation system).

### Description of LD-type BL

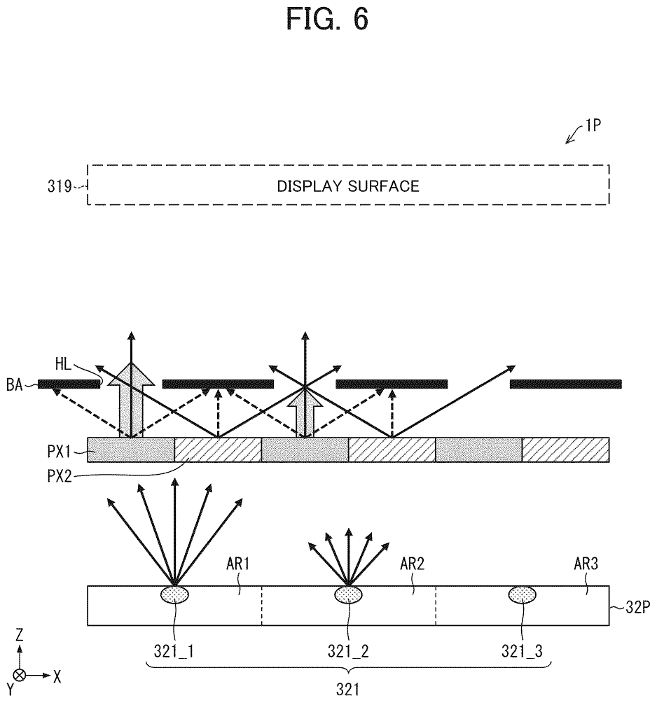

FIG. 6 is a schematic diagram illustrating an operation example of the LD-type BL (e.g., the BL 32P). As shown in FIG. 6, the LD-type BL is divided into a plurality of areas. A first area AR1, a second area AR2, and a third area AR3 all shown in FIG. 6 are examples of the plurality of areas of the BL 32P. The first area AR1 to the third area AR3 are examples of a two-dimensional area described later in detail (two-dimensionally divided areas).

The LD-type BL includes a light source in each of the plurality of areas. In the example in FIG. 6, the BL 32P includes a light source 321 in each of the plurality of areas. The light source 321 is a collective term for the light source in each of the plurality of areas. FIG. 6 shows a first light source 321_1, a second light source 321_2, and a third light source 321_3 as examples of the light source 321. The first light source 321_1 is a light source for the first area AR1, the second light source 321_2 is a light source for the second area AR2, and the third light source 321_3 is a light source for the third area AR3.

The light sources in the LD-type BL are independently controllable in each of the plurality of areas of the BL. Therefore, in the example in FIG. 6, the light sources 321 in the BL 32P are independently controllable in each of the plurality of areas of the BL 32P. Therefore, the BL control unit 22P generates BL data that corresponds to a single input image and that corresponds also to each of the plurality of light sources 321 in the BL 32P. The BL control unit 22P feeds the generated BL data to the BL drive unit 34.

In Embodiment 1, the BL drive unit 34 independently controls the light-emission luminance of each of the plurality of light sources 321 in the BL 32P in accordance with the BL data fed from the BL control unit 22P. In other words, the BL drive unit 34 independently controls the luminance of each of the plurality of areas of the BL 32P in accordance with the BL data fed from the BL control unit 22P.

Therefore, the BL data in Embodiment 1 specifies a light-emission luminance for each of the plurality of light sources 321 in the BL 32P. For this reason, the BL data in Embodiment 1 can be construed as being data representing a luminance for each of the plurality of areas of the BL 32P.

As described here, the BL 32P allows for an LD display in accordance with a single input image. Such an LD display allows for improvement of the contrast ratio of the image displayed on the display surface 319 (image in accordance with the single input image). The LD display also contributes to reduction of power consumption of the BL 32P.

The first area AR1 in the example in FIG. 6 corresponds to one of the locations in the input image to which a maximum gray level is assigned. Therefore, in the example in FIG. 6, the light-emission luminance of the first light source 321_1 is higher than the light-emission luminance of the second light source 321_2.

The second area AR2 in the example in FIG. 6 corresponds to one of the locations in the input image to which an intermediate gray level (a gray level that is intermediate, in other words, that is lower than the maximum gray level and higher than the minimum gray level) is assigned. Therefore, in the example in FIG. 6, the light-emission luminance of the second light source 321_2 is lower than the light-emission luminance of the first light source 321_1.

The third area AR3 in the example in FIG. 6 corresponds to one of the locations in the input image to which the minimum gray level is assigned. The minimum gray level is 0 in Embodiment 1. Therefore, the light-emission luminance of the third light source 321_3 in the example in FIG. 6 is 0. In other words, in the example in FIG. 6, the third light source 321_3 is in a non-emissive state.

Note that the barrier BA in the example in FIG. 6 is formed assuming the positional relationship of the users shown as an example in FIG. 5. In the example in FIG. 6, the first display pixel group PX1 is hardly covered with the barrier BA. Therefore, the vast majority of the first light discharged from the first display pixel group PX1 passes through the openings HL and reaches the display surface 319. As a result, the first image IMG1, which should be presented to the first user U1, is formed on the display surface 319 by the first light that has reached the display surface 319. In Embodiment 1, the first display pixel group PX1 is assumed to be so configured that the first light discharged from the first display pixel group PX1 has a directionality to travel primarily toward the first location.

Meanwhile, the second display pixel group PX2 is covered with the barrier BA. As an example, consider a situation where the second image IMG2 as a non-black display image is presented to the second user U2. The vast majority of the second light discharged from the second display pixel group PX2 is blocked by the barrier BA. However, the second light discharged from the second display pixel group PX2 partially has such a directionality to travel toward the lateral side of the display surface 319. Therefore, of the second light discharged from the second display pixel group PX2, the second light that has a directionality to travel toward the lateral side of the display surface 319 partially passes through the openings HL and reaches the display surface 319. As a result, the second image IMG2, which should be presented to the second user U2, is formed on the display surface 319 by the second light that has reached the display surface 319.

Example of Plurality of Two-dimensional Areas of LD-type BL in accordance with Embodiment 1

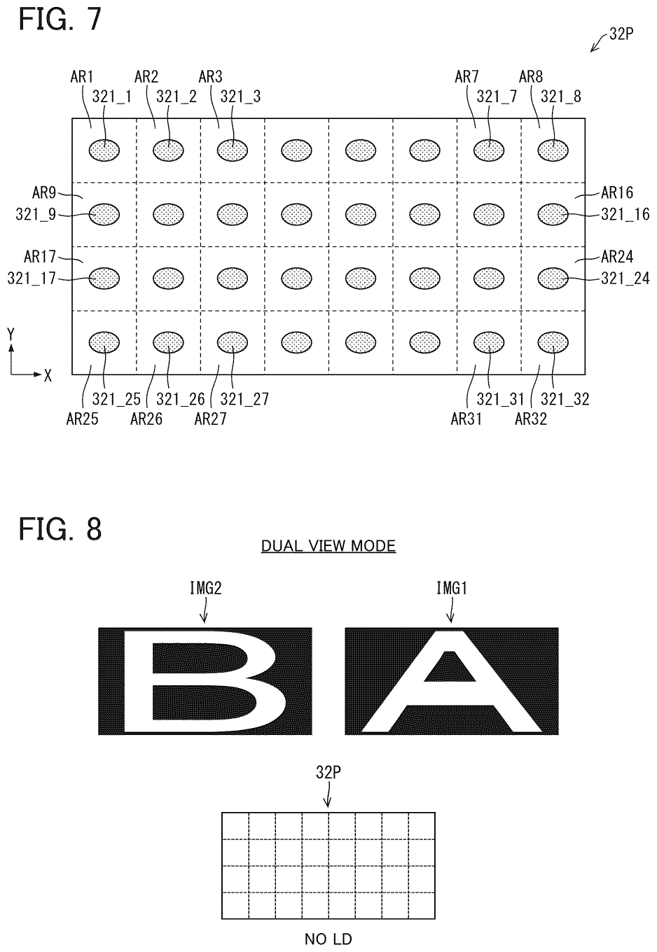

FIG. 7 is a diagram showing a more specific example of the plurality of areas of the BL 32P in accordance with Embodiment 1. The following description of Embodiment 1 discusses an example where the BL 32P is divided into a plurality of two-dimensional areas. The BL 32P is divided into a plurality of two-dimensional areas. In the example in FIG. 7, the BL 32P is divided into 32 individual two-dimensional areas, that is, the first area AR1 to a thirty-second area AR32. In the example in FIG. 7, the 32 individual two-dimensional areas are delimited by equally dividing the BL 32P into eight segments in the X-direction and further equally dividing each of the eight segments into four segments in the Y-direction. As described here, FIG. 7 shows an example of a plurality of two-dimensional areas of the BL 32P in accordance with Embodiment 1.

As described above, the BL 32P includes the light source 321 in each of the plurality of two-dimensional areas. In the example in FIG. 7, the BL 32P includes 32 light sources, that is, the first light source 321_1 to a thirty-second light source 321_32, as the light sources 321. In the present specification, the light source 321 in an i-th area ARi is referred to as an i-th light source 321_i. The letter i is a suffix indicating the individual number given to each two-dimensional area in the BL 32P. In the example in FIG. 7, i is any integer that satisfies 1≤i≤32.

Then, as described above, the light sources 321 are independently controllable in each of the plurality of two-dimensional areas of the BL 32P. Therefore, in the BL 32P, the light-emission luminance of the i-th light source 321_i in the i-th area ARi and the light-emission luminance of a j-th light source 321_j in a j-th area ARj are independently controllable. The letter j is another suffix indicating the individual number given to each two-dimensional area in the BL 32P and differs from i. In the example in FIG. 7, j is any integer that satisfies both 1≤j≤32 and i≠j.

### Control Example of LD-Type BL in Dual View Mode

As described above, an LD display in accordance with a single input image allows for improvement of the contrast ratio of the image displayed on the display surface 319 (image in accordance with the single input image). In other words, such an LD display allows for improvement of the display quality of the single input image.

However, as described above, in dual view mode, the first image IMG1, which is a non-black display image, is presented to the first user U1, and the second image IMG2, which is a different image from the first image IMG1 and is a non-black display image, is presented to the second user U2. Therefore, in dual view mode, data for two different non-black display images, that is, the first image IMG1 and the second image IMG2, is inputted to the control unit 2P.

In such a case, an LD display could be performed in accordance with the gray level distribution of either one of the first image IMG1 and the second image IMG2. Consider, as a first example, a case where an LD display is performed in accordance with the gray level distribution of the first image IMG1. In this case, the LD display in accordance with the gray level distribution of the first image IMG1 contributes to improvement of the display quality of the first image IMG1. However, the LD display in accordance with the gray level distribution of the first image IMG1 does not always contribute to improvement of the display quality of the second image IMG2. There is a concern that the LD display in accordance with the gray level distribution of the first image IMG1 may actually reduce the display quality of the second image IMG2.

Consider, as a second example, a case where an LD display is performed in accordance with the gray level distribution of the second image IMG2. The LD display in accordance with the gray level distribution of the second image IMG2 contributes to improvement of the display quality of the second image IMG2. However, the LD display in accordance with the gray level distribution of the second image IMG2 does not always contribute to improvement of the display quality of the first image IMG1. There is a concern that the LD display in accordance with the gray level distribution of the second image IMG2 may actually reduce the display quality of the first image IMG1.

Accordingly, the control unit 2P in accordance with Embodiment 1 controls the display unit 3P in dual view mode so that the display unit 3P does not perform an LD display. Specifically, in dual view mode, the BL control unit 22P controls the BL 32P so as not to LD-drive the BL 32P. In other words, in dual view mode, the BL control unit 22P controls the BL 32P, which is inherently an LD-type BL, to operate as a non-LD-type BL.

Therefore, in dual view mode, the BL control unit 22P controls the light sources 321 in the BL 32P (e.g., the first light source 321_1 to the thirty-second light source 321_32 in FIG. 7) so as to render uniform all the luminances of the plurality of two-dimensional areas of the BL 32P (e.g., the first area AR1 to the thirty-second area AR32 in FIG. 7).

More specifically, in dual view mode, the BL control unit 22P generates BL data in which the light-emission luminances of all the light sources 321 in the BL 32P are specified to share a uniform value (common value) and feeds this BL data to the BL drive unit 34. Then, the BL drive unit 34 causes all the light sources 321 in the BL 32P to emit light with a uniform luminance in accordance with this BL data. As a result, the BL 32P can be turned into a light-emission state in which all the plurality of two-dimensional areas of the BL 32P emit light with a uniform luminance.

FIG. 8 is a diagram showing examples of the first image IMG1, the second image IMG2, and a BL luminance distribution (luminance distribution of the plurality of two-dimensional areas of the BL 32P) in dual view mode in accordance with Embodiment 1. The first image IMG1 in the example in FIG. 8 is an image representing a capital alphabet letter “A.” Meanwhile, the second image IMG2 is an image representing a capital alphabet letter “B.”

As described above, in dual view mode in accordance with Embodiment 1, the BL 32P is controlled so as not to LD-drive the BL 32P. In other words, the BL 32P is controlled so that all the luminances of the plurality of two-dimensional areas of the BL 32P are rendered uniform. Therefore, in the example in FIG. 8, all the luminances of the plurality of two-dimensional areas of the BL 32P are uniform. In the example in FIG. 8, all the luminances of the plurality of two-dimensional areas of the BL 32P are set to a maximum luminance.

It should be understood however that the uniform luminance of the plurality of two-dimensional areas of the BL 32P in dual view mode in accordance with Embodiment 1 is not necessarily a maximum luminance. For example, with a view to reducing the power consumption of the BL 32P, the uniform luminance of the plurality of two-dimensional areas of the BL 32P in dual view mode may be set to a luminance lower than the maximum luminance. The uniform luminance of the plurality of two-dimensional areas of the BL 32P in dual view mode needs only to be set so that the first user U1 can visually recognize the first image IMG1 without a problem at the first location and also that the second user U2 can visually recognize the second image IMG2 without a problem at the second location.

By not LD-driving the BL 32P in dual view mode in accordance with Embodiment 1, it is possible to prevent the display quality of the second image IMG2 from decreasing due to the LD display performed in accordance with the gray level distribution of the first image IMG1. Then, it is also possible to prevent the display quality of the first image IMG1 from decreasing due to the LD display performed in accordance with the gray level distribution of the second image IMG2. Therefore, the non-LD-driving of the BL 32P in dual view mode contributes to improvement of display quality in dual view mode.

### Description of Public Mode

As described above, in dual view mode, content images as different non-black display images are presented respectively to the first user U1 and the second user U2. It should be understood however that there may be cases where it is preferable to present a common content image to both the first user U1 and the second user U2.

As an example, when the display device 1P is an onboard display device, there may be cases where it is preferable to present a content image that is related to the driving of the automobile (an information image presented by the software included in a car navigation system) to both the first user U1, who is a non-driver, and the second user U2, who is the driver. Accordingly, Embodiment 1 discusses an example where public mode is made available as a display mode other than dual view mode. Note that public mode is alternatively referred to as wide viewing-angle mode.

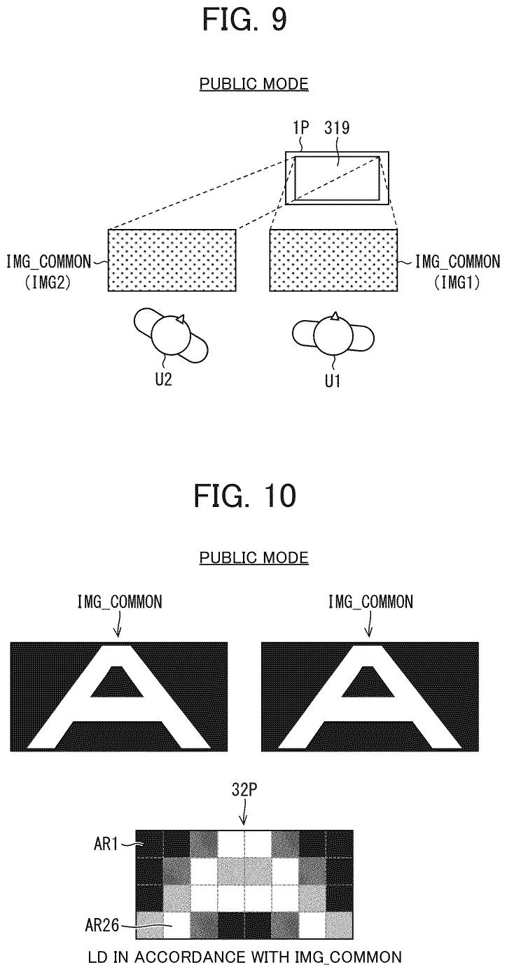

FIG. 9 schematically shows an image display in public mode by the display device 1P. FIG. 9 is a drawing corresponding to FIG. 5. As shown in FIG. 9, in public mode, the display device 1P (i) presents the first image IMG1, which is a non-black display image, to the first user U1 and also (ii) presents a common image that is the same image as the first image IMG1 as the second image IMG2 to the second user U2. In FIG. 9, a non-black display image as this common image is denoted by a reference symbol IMG_COMMON. The common image will be referred to as the common image IMG_COMMON in the following description.

### Control Example of LD-Type BL in Public Mode

As described above, in public mode, unlike in dual view mode, the common image IMG_COMMON is presented to both the first user U1 and the second user U2. Therefore, in public mode, unlike in dual view mode, data for a single non-black display image, that is, the common image IMG_COMMON, is inputted to the control unit 2P.

Accordingly, the control unit 2P in accordance with Embodiment 1 controls the display unit 3P in public mode so that the display unit 3P performs an LD display. Specifically, the control unit 2P controls the display unit 3P in public mode so that the display unit 3P performs an LD display in accordance with the common image IMG_COMMON. Therefore, in public mode, the BL control unit 22P controls the BL 32P so as to LD-drive the BL 32P in accordance with the common image IMG_COMMON.

Specifically, in public mode, the BL control unit 22P specifies a luminance for each of the plurality of two-dimensional areas of the BL 32P by controlling the light sources 321 in the BL 32P in accordance with the gray level distribution of the common image IMG_COMMON.

More specifically, in public mode, the BL control unit 22P generates BL data in which the light-emission luminances of the plurality of light sources 321 in the BL 32P are specified in accordance with the gray level distribution of the common image IMG COMMON and feeds this BL data to the BL drive unit 34. Then, the BL drive unit 34 causes each of the plurality of light sources 321 in the BL 32P to emit light in accordance with the BL data. As a result, the BL 32P can be turned into a light-emission state in which the plurality of two-dimensional areas of the BL 32P emit light with a luminance that is in accordance with the gray level distribution of the common image IMG_COMMON.

FIG. 10 is a diagram showing examples of the common image IMG_COMMON (in other words, the first image IMG1 and the second image IMG2 in public mode) and the BL luminance distribution in public mode in accordance with Embodiment 1. FIG. 10 is a drawing corresponding to above-described FIG. 8. As described above, in public mode in accordance with Embodiment 1, the BL 32P is controlled so as to LD-drive the BL 32P in accordance with the common image IMG_COMMON. Therefore, in the example in FIG. 10, unlike in the example in FIG. 8, all the luminances of the plurality of two-dimensional areas of the BL 32P are not uniform.

The BL luminance distribution in the example in FIG. 10 corresponds to the gray level distribution of the common image IMG_COMMON. Consider, as an example, a case where in public mode, the gray level at a location in the common image IMG_COMMON is higher than the gray level at another location in the common image IMG_COMMON. In this case, typically, the luminance of one of the plurality of two-dimensional areas of the BL 32P that corresponds to a location in the common image IMG_COMMON is higher than the luminance of another one of the plurality of two-dimensional areas that corresponds to another location in the common image IMG_COMMON. FIG. 10 shows an example of such a correspondence between the gray level distribution of the common image IMG_COMMON and the BL luminance distribution in public mode (see, for example, the first area AR1 and a twenty-sixth area AR26 of the BL 32P in the example in FIG. 10).

In public mode in accordance with Embodiment 1, by LD-driving the BL 32P in accordance with the common image IMG_COMMON, it is possible to improve the display quality of the common image IMG_COMMON as it is visually recognized by the first user U1 at the first location and also to improve the display quality of the common image IMG_COMMON as it is visually recognized by the second user U2 at the second location. Therefore, the LD-driving of the BL 32P in accordance with the common image IMG_COMMON in public mode contributes to improvement of display quality in public mode.

### Description of Privacy Mode

As described above, in dual view mode and in public mode, a content image as a non-black display image is presented to the second user U2. It should be understood however that there may be cases where it is preferable to present a content image only to the first user U1 and not to present a content image to the second user U2.

Assume, as an example, a case where when the display device 1P is an onboard display device, the second user U2 may preferably be let to concentrate on the driving of the automobile. For example, to prevent the second user U2 from being distracted from driving, it may be preferable to deliberately not present a content image to the second user U2. Accordingly, Embodiment 1 discusses an example where privacy mode is made available as a display mode other than dual view mode and public mode. Note that privacy mode is alternatively referred to as narrow viewing-angle mode.

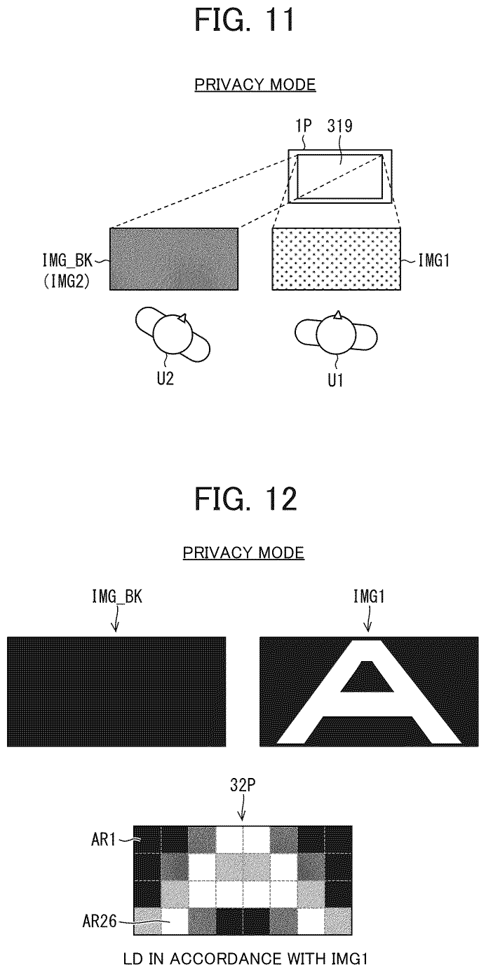

FIG. 11 schematically shows an image display in privacy mode by the display device 1P. FIG. 11 is also a drawing corresponding to FIG. 5. As shown in FIG. 11, in privacy mode, the display device 1P (i) presents the first image IMG1, which is a non-black display image, to the first user U1 and also (ii) presents a black display image as the second image IMG2 to the second user U2. In FIG. 11, a black display image as the second image IMG2 is denoted by a reference symbol IMG_BK.

### Control Example of LD-Type BL in Privacy Mode

As described above, in privacy mode, a black display image IMG_BK is presented to the second user U2. Therefore, in privacy mode, data for a single non-black display image, that is, the first image IMG1, is inputted to the control unit 2P. Privacy mode can be described as being similar to public mode in that data for a single non-black display image is inputted to the control unit 2P.

Accordingly, the control unit 2P in accordance with Embodiment 1 controls the display unit 3P also in privacy mode so that the display unit 3P performs an LD display. Specifically, the control unit 2P controls the display unit 3P in public mode so that the display unit 3P performs an LD display in accordance with the first image IMG1. Therefore, in privacy mode, the BL control unit 22P controls the BL 32P so as to LD-drive the BL 32P in accordance with the first image IMG1.

Specifically, in privacy mode, the BL control unit 22P specifies a luminance for each of the plurality of two-dimensional areas of the BL 32P by controlling the light sources 321 in the BL 32P in accordance with the gray level distribution of the first image IMG1.

More specifically, in privacy mode, the BL control unit 22P generates BL data in which the light-emission luminance of the plurality of light sources 321 in the BL 32P are specified in accordance with the gray level distribution of the first image IMG1 and feeds this BL data to the BL drive unit 34. Then, the BL drive unit 34 causes each of the plurality of light sources 321 in the BL 32P to emit light in accordance with the BL data. As a result, the BL 32P can be turned into a light-emission state in which the plurality of two-dimensional areas of the BL 32P emit light with a luminance that is in accordance with the gray level distribution of the first image IMG1.

FIG. 12 is a diagram showing examples of the first image IMG1, the black display image IMG_BK (in other words, the second image IMG2 in privacy mode), and the BL luminance distribution in privacy mode in accordance with Embodiment 1. FIG. 12 is also a drawing corresponding to FIG. 8. As described above, in privacy mode in accordance with Embodiment 1, the BL 32P is controlled so as to LD-drive the BL 32P in accordance with the first image IMG1. Therefore, in the example in FIG. 12, unlike in the example in FIG. 8, all the luminances of the plurality of two-dimensional areas of the BL 32P are also not uniform.

The BL luminance distribution in the example in FIG. 12 corresponds to the gray level distribution of the first image IMG1. Consider, as an example, a case where in privacy mode, the gray level at a location in the first image IMG1 is higher than the gray level at another location in the first image IMG1. In this case, typically, the luminance of one of the plurality of two-dimensional areas of the BL 32P that corresponds to a location in the first image IMG1 is higher than the luminance of another one of the plurality of two-dimensional areas that corresponds to another location in the first image IMG1. FIG. 12 shows an example of such a correspondence between the gray level distribution of the first image IMG1 and the BL luminance distribution in privacy mode (see, for example, the first area AR1 and the twenty-sixth area AR26 of the BL 32P in the example in FIG. 12).

In privacy mode in accordance with Embodiment 1, by LD-driving the BL 32P in accordance with the first image IMG1, it is possible to improve the display quality of the first image IMG1 as it is visually recognized by the first user U1 at the first location. Meanwhile, it is intended in privacy mode not to present a non-black display image as a content image to the second user U2. For this reason, in privacy mode, it is not necessary to improve the display quality of the black display image IMG_BK as it is visually recognized by the second user U2 at the second location. Therefore, the LD-driving of the BL 32P in privacy mode in accordance with the first image IMG1 contributes to improvement of display quality in privacy mode.

### Effects

As described so far, the control unit 2P in accordance with Embodiment 1 specifies a luminance for each of the plurality of two-dimensional areas of the BL 32P by controlling the light sources 321 in the BL 32P in accordance with the display mode of the display device 1P. Specifically, the control unit 2P switches between LD-driving of the BL 32P and non-LD-driving of the BL 32P in accordance with the display mode of the display device 1P.

Therefore, when the LD-driving of the BL 32P could undesirably lead to decreases in the display quality of the display device 1P, the BL 32P is controlled so as not to perform LD-driving. Specifically, when the display device 1P is operating in dual view mode, the BL 32P is controlled so as not to perform LD-driving.

Meanwhile, when the LD-driving of the BL 32P would contribute to improvement of the display quality of the display device 1P without undesirably leading to decreases in the display quality of the display device 1P, the BL 32P is controlled so as to LD-drive the BL 32P. Specifically, when the display device 1P is operating in public mode or in privacy mode, the BL 32P is controlled so as to LD-drive the BL 32P.

As described so far, Embodiment 1 can improve the display quality of the display device 1P by selectively LD-driving the BL 32P in accordance with the display mode of the display device 1P. As described here, the display device 1P can improve the display quality of a multi-view display device over known devices. Specifically, the display device 1P can improve the display quality of an LD-type multi-view display device over known devices.

### Supplemental Description

FIGS. 5, 9, and 11 of Embodiment 1 show examples where the first location is a location in front of the display surface 319 and the second location is a location on a lateral side of the display surface 319. It should be understood however that the first location and the second location in Embodiment 1 are not necessarily limited to these examples.

For instance, in Embodiment 1, similarly to the example in FIG. 2 of Reference Embodiment, the first location may be on either one of the left side of the display surface 319 and the right side of the display surface 319, and the second location may be on the other one of the left side of the display surface 319 and the right side of the display surface 319. As described here, also in Embodiment 1, the second location may be a location on a lateral side of the display surface 319 and may be a location on a lateral side that is opposite the first location.

Therefore, it should be noted that the positional relationship of the first display pixel group PX1, the second display pixel group PX2, and the openings HL in Embodiment 1 is not necessarily limited to the example in FIG. 6 in Embodiment 1. As an example, Embodiment 1 may employ the positional relationship of the first display pixel group PX1, the second display pixel group PX2, and the openings HL that is shown as an example in FIG. 3 in Reference Embodiment.

### Software Implementation Example

The functions of the display devices 1 to 1P (hereinafter, the “device(s)”) may be implemented by a program causing a computer to function as the device and causing a computer to function as the control blocks of the device (in particular, each part contained in the control units 2 to 2P).

In such cases, the device includes a computer including at least one control device (e.g., a processor) and at least one storage device (e.g., a memory) as hardware for executing the program. The functions described in the embodiments above are implemented by these control and storage devices executing the program.

The program may be stored not temporarily, but in one or more computer-readable storage media. The storage medium/media may or may not be provided in the device. In the latter case, the program may be delivered to the device via any wired or wireless transmission medium.

Alternatively, the functions of the control blocks may be partially or entirely implemented by logic circuitry. For instance, the scope of an aspect of the present disclosure encompasses integrated circuits including logic circuitry that functions as the control blocks. As another alternative, the functions of the control blocks may be implemented by, for example, a quantum computer.

The processes described in the embodiments may be implemented by AI (Artificial Intelligence). In such cases, the AI may run on the control device or may run on another device (e.g., an edge computer or a cloud server).

### General Description

The present disclosure, in aspect 1 thereof, is directed to a display device capable of presenting a first image to a first user positioned at a first location in front of a display surface and also of presenting a second image to a second user positioned at a second location other than the first location, the display device including: a display panel including a first display pixel group that contributes to formation of the first image on the display surface and a second display pixel group that contributes to formation of the second image on the display surface; a backlight configured to discharge illumination light toward the first display pixel group and the second display pixel group; a barrier configured to prevent part of first light produced by wavelength-converting the illumination light with the first display pixel group and part of second light produced by wavelength-converting the illumination light with the second display pixel group from traveling toward the display surface; and a control unit configured to control the display panel and the backlight, wherein the backlight is divided into a plurality of two-dimensional areas, the backlight includes a light source in each of the plurality of two-dimensional areas, the light sources are independently controllable in each of the plurality of two-dimensional areas of the backlight, and the control unit specifies a luminance for each of the plurality of two-dimensional areas of the backlight by controlling the light sources in the backlight in accordance with a display mode of the first image and the second image.

In the display device of aspect 2 of the present disclosure, in aforementioned aspect 1, the display mode may include dual view mode, in the dual view mode, the display device may (i) present the first image that is not a black display image to the first user and also (ii) present the second image that differs from the first image and that is not a black display image to the second user, and the control unit may, in the dual view mode, control the light sources in the backlight so that all the plurality of two-dimensional areas of the backlight exhibit a uniform luminance.

In the display device of aspect 3 of the present disclosure, in aforementioned aspect 1 or 2, the display mode may include public mode, in the public mode, the display device may (i) present the first image that is not a black display image to the first user and also (ii) present a common image that is the same image as the first image as the second image to the second user, and the control unit may, in the public mode, specify a luminance for each of the plurality of two-dimensional areas of the backlight by controlling the light sources in the backlight in accordance with a gray level distribution of the common image.

In the display device of aspect 4 of the present disclosure, in aforementioned aspect 3, in the public mode, when the common image has a higher gray level at a location in the common image than at another location in the common image, one of the plurality of two-dimensional areas of the backlight that corresponds to the location in the common image may exhibit a higher luminance than another one of the plurality of two-dimensional areas of the backlight that corresponds to the other location in the common image.

In the display device of aspect 5 of the present disclosure, in any one of aforementioned aspects 1 to 4, the display mode may include privacy mode, in the privacy mode, the display device may (i) present the first image that is not a black display image to the first user and also (ii) present a black display image as the second image to the second user, and the control unit may, in the privacy mode, specify a luminance for each of the plurality of two-dimensional areas of the backlight by controlling the light sources in the backlight in accordance with a gray level distribution of the first image.

In the display device of aspect 6 of the present disclosure, in aforementioned aspect 5, in the privacy mode, when the first image has a higher gray level at a location in the first image than at another location in the first image, one of the plurality of two-dimensional areas of the backlight that corresponds to the location in the first image may exhibit a higher luminance than another one of the plurality of two-dimensional areas of the backlight that corresponds to the other location in the first image.

In the display device of aspect 7 of the present disclosure, in any one of aforementioned aspects 1 to 6, the first location may be a location in front of the display surface, and the second location may be a location on a lateral side of the display surface.

In the display device of aspect 8 of the present disclosure, in any one of aforementioned aspects 1 to 6, the first location may be a location on either one of a left side of the display surface and a right side of the display surface, and the second location may be a location on another one of the left side of the display surface and the right side of the display surface.

In the display device of aspect 9 of the present disclosure, in any one of aforementioned aspects 1 to 8, the display panel may be a liquid crystal display panel.

### Additional Remarks

The present disclosure, in an aspect thereof, is not limited to the description of the embodiments above and may be altered in various manners within the scope of the claims. Embodiments based on a proper combination of technical means disclosed in different embodiments are also encompassed in the technical scope of the aspect of the present disclosure. Furthermore, new technical features can be created by combining different technical means disclosed in the embodiments.

What is claimed is:

1. A display device capable of presenting a first image to a first user positioned at a first location in front of a display surface and also of presenting a second image to a second user positioned at a second location other than the first location, the display device comprising:
a display panel including a first display pixel group that contributes to formation of the first image on the display surface and a second display pixel group that contributes to formation of the second image on the display surface;
a backlight configured to discharge illumination light toward the first display pixel group and the second display pixel group;
a barrier configured to prevent part of first light produced by wavelength-converting the illumination light with the first display pixel group and part of second light produced by wavelength-converting the illumination light with the second display pixel group from traveling toward the display surface; and
a control unit configured to control the display panel and the backlight, wherein
the backlight is divided into a plurality of two-dimensional areas,
the backlight includes a light source in each of the plurality of two-dimensional areas,
the light sources are independently controllable in each of the plurality of two-dimensional areas of the backlight, and
the control unit specifies a luminance for each of the plurality of two-dimensional areas of the backlight by controlling the light sources in the backlight in accordance with a display mode of the first image and the second image.

2. The display device according to claim 1, wherein
the display mode includes dual view mode,
in the dual view mode, the display device (i) presents the first image that is not a black display image to the first user and also (ii) presents the second image that differs from the first image and that is not a black display image to the second user, and
the control unit, in the dual view mode, controls the light sources in the backlight so that all the plurality of two-dimensional areas of the backlight exhibit a uniform luminance.

3. The display device according to claim 1, wherein
the display mode includes public mode,
in the public mode, the display device (i) presents the first image that is not a black display image to the first user and also (ii) presents a common image that is a same image as the first image as the second image to the second user, and
the control unit, in the public mode, specifies a luminance for each of the plurality of two-dimensional areas of the backlight by controlling the light sources in the backlight in accordance with a gray level distribution of the common image.

4. The display device according to claim 3, wherein in the public mode, when the common image has a higher gray level at a location in the common image than at another location in the common image, one of the plurality of two-dimensional areas of the backlight that corresponds to the location in the common image exhibits a higher luminance than another one of the plurality of two-dimensional areas of the backlight that corresponds to the other location in the common image.

5. The display device according to claim 1, wherein
the display mode includes privacy mode,
in the privacy mode, the display device (i) presents the first image that is not a black display image to the first user and also (ii) presents a black display image as the second image to the second user, and
the control unit, in the privacy mode, specifies a luminance for each of the plurality of two-dimensional areas of the backlight by controlling the light sources in the backlight in accordance with a gray level distribution of the first image.

6. The display device according to claim 5, wherein in the privacy mode, when the first image has a higher gray level at a location in the first image than at another location in the first image, one of the plurality of two-dimensional areas of the backlight that corresponds to the location in the first image exhibits a higher luminance than another one of the plurality of two-dimensional areas of the backlight that corresponds to the other location in the first image.

7. The display device according to claim 1, wherein
the first location is a location in front of the display surface, and
the second location is a location on a lateral side of the display surface.

8. The display device according to claim 1, wherein
the first location is a location on either one of a left side of the display surface and a right side of the display surface, and
the second location is a location on another one of the left side of the display surface and the right side of the display surface.

9. The display device according to claim 1, wherein the display panel is a liquid crystal display panel.
